(19) United States
(12) Patent Application Publication
(10) Pub. No.: US 2016/0004744 A1
(43) Pub. Date: Jan. 7, 2016

(54) TOP-K SEARCH USING SELECTED PAIRWISE COMPARISONS

(71) Applicants: Brian Charles ERIKSSON, (US); THOMSON LICENSING, Issy-les-Moulineaux (FR)

(72) Inventor: Brian Charles ERIKSSON, San Jose, CA (US)

(21) Appl. No.: 14/768,620

(22) PCT Filed: Jul. 25, 2013
(86) PCT No.: PCT/US2013/052008

§ 371 Date: Aug. 18, 2015

Related U.S. Application Data
(60) Provisional application No. 61/773,970, filed on Mar. 7, 2013.

(51) Int. Cl. G06F 17/30

(52) U.S. Cl. CPC G06F 17/30395; G06F 17/30477

(57) ABSTRACT

A method and apparatus for determining a pre-determined number of top ranked items is described including accepting a probability of the method failing, iteratively performing the following steps, accepting the set of unranked items and the probability of erroneous pairwise comparisons, randomly selecting a pre-determined number of items from the set of unranked items, querying multiple observed pairwise comparisons, determining items of the set of unranked items that are in a top portion and in a bottom portion of the set of unranked items based on the query, reducing the set of unranked items by removing the items in the bottom portion and the top portion of the set of unranked items responsive to the determining step, querying the multiple observed pairwise comparisons, reducing the set of unranked items by removing items in the bottom portion of the set of unranked items responsive to the second querying step and returning the reduced set of unranked items.

This application claims priority to U.S. Provisional Application No. 61/773,970 entitled “Top-K Search Using Selected Pairwise Comparisons”, filed on Mar. 7, 2013, which is hereby incorporated by reference in its entirety.

### FIELD OF THE INVENTION

The present invention relates to recommendation and voting systems.

### BACKGROUND OF THE INVENTION

Naïve solutions to the top-k item problem require all N*(N-1)/2 pairwise comparisons to be observed. Often, there is significant cost to obtain each comparison. For example, in the recommender systems problem, each comparison query is the result of a user being asked to compare two items (e.g., movies, music, etc.), where each user will maintain engagement only for a small number of comparisons. When N is very large, obtaining all of the pairwise comparisons is prohibitively expensive.

A geometric approach to learning the rank of a set of items was attempted by K. Jamieson and R. Nowak in “Active Ranking using Pairwise Comparisons,” in Neural Information Processing Systems (NIPS), Granada, Spain, December 2011 and by A. Karbasi, S. Ioannidis, and L. Massouli, in “Comparison-Based Learning with Rank Nets,” International Conference on Machine Learning (ICML), Edinburgh, Scotland, June 2012. Both techniques are dependent on the items lying on an underlying low-dimension Euclidean space, with the ranking conforming to the distances between the items in this space. When this embedding information (i.e., item coordinates) is not known beforehand, these techniques require the user to learn the placement of each item in this Euclidean space requiring (1) the execution of an embedding methodology and (2) knowledge of the dimensionality of the item embedding. Both of these requirements will potentially introduce noise in the ranking estimation.

Very little prior work has been done on a “passive sampling” system, where the pairwise comparisons are observed at-random. Some brief analysis in Jamison et al. demonstrates resolving the entire ranking of the items would require almost all the pairwise comparisons when observed at-random. In addition, S. Negahban, S. Oh, and D. Shah, “Iterative Ranking from Pairwise Comparisons” in NIPS Conference, Lake Tahoe, Calif., December 2012 present a technique for inferring ranking from significantly fewer than all pairwise comparisons observed at random. Their main results show how the entire inferred ranking (not just the top-k ranking) error decreases as the number of items grows given multiple observations of each pair of items. The present invention differs from the prior approaches since the present invention only considers a single observation for each pairwise comparison, and the results are derived with respect to finding the top ranked items exactly (not bounding a specified ranking error rate).

Ignoring geometry, the work in N. Ailon, in “An Active Learning Algorithm for Ranking from Pairwise Preferences with an Almost Optimal Query Complexity,” Journal of Machine Learning Research (JMLR), vol. 13, January 2012, pp. 137-164 is similar to the present invention since it uses adaptively chosen pairwise comparisons with a voting methodology to determine the ranking of the items. The query complexity bounds are derived for resolving an approximation of the entire ranking in Ailon. The present invention differs as a result of a novel two-stage voting technique that allows for (1) the top ranked items to be found exactly with high probability (vs. a noisy estimate of the entire ranking in Ailon) and (2) significantly fewer pairwise comparisons to be queried. The present invention uses only O(N log²(N)) vs. O(N log⁵(/V)) in Ailon.

Recent work by A. Ammar and D. Shah, “Efficient Rank Aggregation using Partial Data,” in ACM SIGMETRICS Conference, London, England, June 2012, pp. 355-366 has shown how the top ranked items from pairwise comparisons can be resolved using a maximum entropy distribution technique using all pairwise comparisons. In contrast to this prior work, analysis presented herein focuses on resolving the top-ranked items exactly with high probability, while making no assumptions as to the underlying embedding or distribution of the items.

### SUMMARY OF THE INVENTION

Consider N=1,000,000 movies in the recommendation database and a goal of finding the 20 best films to recommend to all users. Given that everyone has a different internal 5-star scale (i.e., a rating of three stars to user 1 is different than three stars to user 2), instead individual users are asked to compare two movies, “Is movie A better than movie B?”. The present invention adaptively decides which specific movies to compare against so that the best films (i.e., the top items) can be determined while asking only a few comparison questions. Using the group of all users, these questions could be spread across the entire user base to minimize the total number of comparison questions each user is asked. Of course, each user can make mistakes, either through the interface (clicking the wrong item), or by having preferences outside the mainstream of most users. This introduces errors into the system, but using the present invention the introduction of these types of errors can be defeated with a small number of additional comparisons.

The statistical bounds for the present invention requires only O(Nlog²(N)) comparisons to find the top items. So if the number of movies in the system is roughly equal to the number of users, then each user would on average need to answer only log² (N) comparison questions. For N=1,000,000 movies, the statistical bounds derived herein would only require each user to answer roughly 36 comparison questions to accurately resolve the top films in the database. These derived bounds are actually pretty conservative, and via experiments it was found that accurate suggestions of the top items can be found with only O(Nlog(N)) comparisons, and so each user may only need to answer roughly 6 questions on average. It would all depend on how much error the users introduce into the system via erroneous comparisons, and how much accuracy is desired in terms of the top films suggested.

A method and apparatus for determining a pre-determined number of top ranked items are described including accepting a set of unranked items, the pre-determined number, and a random selection of pairwise comparisons, creating a graph structure using the set of unranked items and the random selection of pairwise comparisons, wherein the graph structure includes vertices corresponding to the items and edges corresponding to a pairwise ranking and performing a depth-first search for each item that is an element of the set of unranked items for paths along the edges through the graph that are not greater than a length equal to the pre-determined number.

Also described are a method and apparatus for determining a pre-determined number of top ranked items including accepting a set of unranked items, a probability of erroneous pairwise comparisons, and a probability of the method failing, determining if the set of unranked items is greater than a maximum of a first threshold and a second threshold, iteratively performing the following steps, accepting the set of unranked items, and the probability of erroneous pairwise comparisons, randomly selecting a pre-determined number of items from the set of unranked items, querying multiple observed pairwise comparisons, determining items of the set of unranked items that are in a top portion and in a bottom portion of the set of unranked items based on the query, reducing the set of unranked items by removing the items in the bottom portion and the top portion of the set of unranked items responsive to the determining step, querying the multiple observed pairwise comparisons, reducing the set of unranked items by removing items in the bottom portion of the set of unranked items responsive to the second querying step, and returning the reduced set of unranked items.

### BRIEF DESCRIPTION OF THE DRAWINGS

The present invention is best understood from the following detailed description when read in conjunction with the accompanying drawings. The drawings include the following figures briefly described below:

FIG. 1 is a graph of an example of a complete comparison graph of five items in ranked order.

FIG. 2 is a set of incomplete comparison graphs of five items.

FIG. 3 is a diagram of an exemplary PathRank algorithm in accordance with the principles of the present invention.

FIG. 4 is a diagram of exemplary RobustAdaptiveSearch and AdaptiveReduce algorithms in accordance with the principles of the present invention.

FIG. 5 is a flowchart of an exemplary PathRank algorithm in accordance with the principles of the present invention.

FIG. 6 is a flowchart of an exemplary RobustAdaptiveSearch algorithm in accordance with the principles of the present invention.

FIG. 7 is a flowchart of an exemplary AdaptiveReduce algorithm in accordance with the principles of the present invention.

FIG. 8 is a block diagram of an exemplary embodiment of the PathRank method of the present invention.

FIG. 9 is a block diagram of an exemplary embodiment of the RobustAdaptiveSearch and AdaptiveReduce methods of the present invention.

### DETAILED DESCRIPTION OF THE PREFERRED EMBODIMENTS

Given a collection of N items with some unknown underlying ranking, how to use pair-wise comparisons to determine the top ranked items in the set is examined. Resolving the top items from pairwise comparisons has application in diverse fields. Techniques are introduced herein to resolve the top ranked items using significantly less than all the possible pairwise comparisons and using both random and adaptive sampling methodologies. Using randomly-chosen comparisons, a graph-based technique is shown to efficiently resolve the top O(log N) items when there are no comparison errors. In terms of adaptively-chosen comparisons, it is shown how the top O(log N) items can be found, even in the presence of corrupted observations, using a voting methodology that only requires O(N log²N) pairwise comparisons.

Consider the “learning to rank problem”, where a set of N items, X{32 1, 2, . . . , N}, has unknown underlying ranking defined by the mapping π:{1, 2, . . . , N}→{1, 2, . . . , N}, such that item i is ranked higher than item j (i.e., i [symbol] j) if πᵢ<πⱼ. Instead of resolving the entire item ranking, a goal of the present invention is to return the k top ranked items, the set {xε{1, 2, . . . , N}:πₓ≦k}. Possible applications range from determining the top papers submitted to a conference, to the recommender systems problem of finding the best items to present to a user based on prior preferences. A critical problem is to determine a sequence of queries to efficiently resolve the top ranked items. Focus is placed on determining the top-k items using pairwise comparisons. This can be considered asking the following question, “Is item i ranked higher than item j?”, which only returns if πᵢ<πⱼ or πⱼ<πᵢ. Unfortunately, when considering pairwise comparisons, the exhaustive set of all O(N²) comparisons is often prohibitively expensive to obtain. For example, in the case of comparing protein structures, each pairwise structure comparison requires significant computation time. In the recommender systems context, there are significant limitations in terms of user engagement, where each user will resolve only a small number of pairwise queries. The present invention focuses on estimating a specified number of top ranked items using significantly fewer than all the pairwise comparisons. The problem of estimating the top-k items is approached using two distinct methodologies. The first methodology exploits a constant fraction of the pairwise comparisons observed at-random in concert with a graph-based methodology to find the top O (log N) ranked items. The second technique uses a two-stage voting methodology to adaptively sample pairwise comparisons to discover the top O (log N) items using only O (N log²N) pairwise comparisons. It is shown herein how this adaptive technique is robust to a significant number of incorrect pairwise comparison queries with respect to the underlying ranking.

Let X={1, 2, . . . , N} be a collection of N items with underlying ranking defined by the mapping π:{1, 2, . . . , N}→{1, 2, . . . , N}, such that item {xε{1, 2, . . . , N}:πₓ =1} is the top-ranked item (i.e., the most preferred), and item {xε{1, 2, . . . , N}:πₓ=N} is the bottom-ranked item (i.e., the least preferred). It is assumed that there are no ties in the ranking. To describe subsets of items in the underlying ranking the following terminology is used:

Definition 1. The item subset {xε{1, 2, . . . , N}:πₓ≦k₁} are the top-k₁ items.

Definition 2. The item subset {xε{1, 2, . . . , N}:πₓ>N-k₂} are the bottom-k₂ items.

Definition 3. The item subset {xε{1, 2, . . . , N}:k_{A}<πₓ≦k_{B}} are the middle-{k_{A}, k_{B}} items.

A goal of the present invention is to return the top-k items, for some specified k>0. Unfortunately, the given item set X={1, 2, . . . , N} is unordered. To determine the collection of top ranked items, pairwise comparisons are queried.

Definition 4. A pairwise comparison matrix, C is defined, where,

c=ᵢⱼ=1 if πᵢ<πⱼ and cᵢⱼ=0 otherwise (1)

As stated above, in many applications not all O(N²) pairwise comparisons (i.e., the entire matrix, C) will be available. To denote this incompleteness, an indicator matrix of similarity observations, Ω is defined, such that Ωᵢⱼ=1 if the pairwise comparison cᵢⱼ has been observed and Ωᵢⱼ=0 if the pairwise comparison cᵢⱼ is not observed (i.e., the pairwise comparison is unknown).

Below the case is considered where these comparison queries can be returned with incorrect information that does not conform to the underlying ranking. These errors are modeled as independent and identically distributed random variables with probability bounded by q≧0, such that,

P(cᵢⱼ=1(πᵢ<πⱼ))≦q (2)

where the indicator function, 1 (E)=1 if the event E occurs, and equals zero otherwise.

There are many situations where the ability to adaptively query pairwise comparisons is unavailable. Instead, only a subset of randomly-chosen comparisons is communicated, where the algorithm has no control over which pairwise comparisons are observed. Given the indicator matrix of similarity observations, Ω, such that 2 Ωᵢⱼ=1 if the pairwise comparison cᵢⱼ has been observed, each comparison is modeled as observed with independent and identically distributed random variables with probability p, such that for all i,j,

P(Ωᵢⱼ=1)=p (3)

where p>0. While prior work states that effectively all the pairwise comparisons will be required to find the entire ranking, a goal here will be to determine the top-ranked items. For this at-random sampling regime, the case is considered where all the pairwise comparisons conform exactly to the underlying ranking (i.e., the probability of incorrect comparison, q=0). One practical example of this regime is the recommender systems problem where users will compare items (one example, via indirect measurements that a user watched movie A more times or longer than movie B), but there is no control over which items they will compare, therefore the pairwise observations can be considered “at-random”.

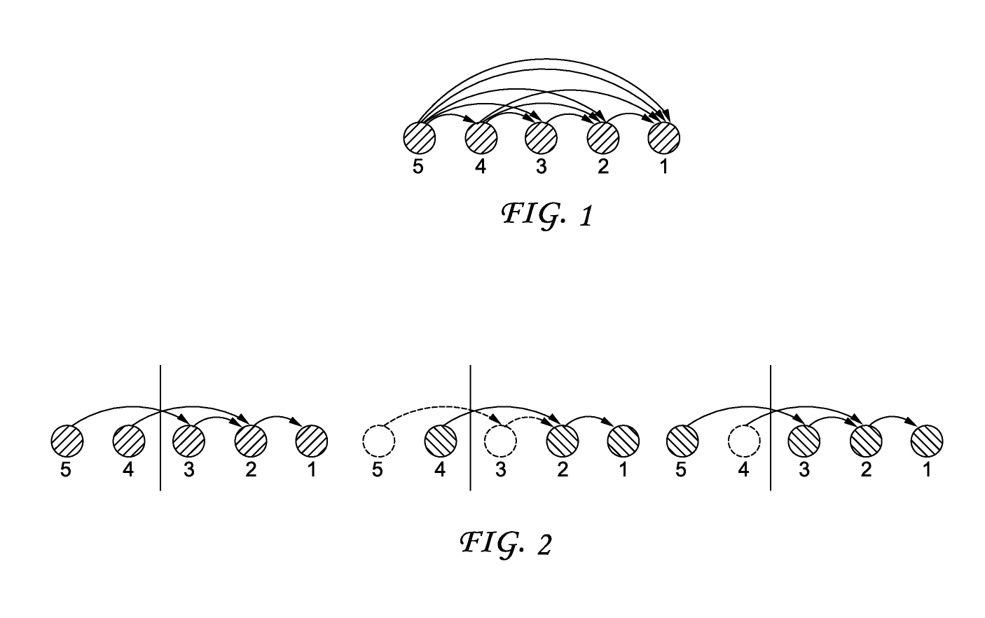

The approach of the present invention is to analyze the graph structure provided by randomly observed pairwise comparisons. Consider the “sampling comparison graph”, G={ V,E}, where the set of vertices represent each item, and the set of edges consist of εᵢⱼ=1 if Ωᵢⱼ=1 (i.e., the pairwise comparison between i,j is observed) and cᵢⱼ=0 (i.e., j [symbol] i). That is, the vertices are each observed item and an edge exists between item i (vertex i) and item j (vertex j) only is item i is found to be higher in rank that item j. An example of this comparison graph can be seen in FIG. 1. FIG. 1 shows a complete comparison graph (Ωᵢⱼ=1 for all i,j) of five items in ranked order 1 [symbol] 2 [symbol] 3 [symbol] 4 [symbol] 5.

On this directed acyclic graph, the path length is defined as the number of item nodes traversed between two connected vertices. The following assumption can be made: If an item i is in the top-k ranked items, then there will never exist a path through the graph G of length>k originating at vertex i. Therefore, resolving the top-k items using this graph structure follows the rule of discarding all items that have paths of length>k to any other item. This PathRank methodology is described in Algorithm 1.

Algorithm 1 - PATHRANK(X,k,C_{Ω})

| Given: | |
|---|---|
| 1. | Set of unranked items, X = {1,2,...,N}. |
| 2. | Specified minimum number of top-ranked items |
| | to resolve, k > 1. |
| 3. | Random selection of pairwise comparisons, C_{Ω}, |
| | Where Ω_{i,j} = 1 if the pairwise comparison between |
| | items i,j was observed. |
| Methodology: | |
| 1. | Create graph structure [symbol] = { [symbol] , [symbol] }. Where the |
| | set of vertices, [symbol] = {1,2,...,N}, and the set of |
| | edges [symbol] _{i,j} = 1, if Ω_{i,j} = 1 and c_{i,j} = 0. |
| 2. | Define the reduced set of items, Y = { }. |
| 3. | For each item, i ∈ X, |

| | |
|---|---|
| (a) | Using the graph structure, [symbol] , perform a |
| | depth-first-search starting at vertex i. If |
| | there does not exist any paths through [symbol] |
| | starting at vertex i of length > k, then add |
| | item i to reduced item set Y. |

Output:
Return the resolved top items found, Y.

Analysis performed shows that when the probability of comparison observation is a constant (i.e., does not scale with the number of items, N), then this technique will find the top-O(log(N)) items with high probability. The resolution of the top items found (i.e., it is preferable to find a smaller number of top ranked items) is directly proportional to the number of comparisons observed, with the tradeoff that more comparisons requires more user engagement that may not be available.

The technique of the present invention was implemented and demonstrated on synthetic data (where the number of items, N, and the observation rate, p was controlled). It was found that in practice the algorithm of the present invention performs better than conservative analysis. For example, with 5,000 items and p=0.05 (five percent of the comparisons observed at-random), it was found that a subset of the top-103 items can be found. With 10,000 items and p=0.03 (only three percent of comparisons observed at-random), it was found that a subset of the top-170 items can be found.

Consider N=1,000,000 movies in the recommendation database and the goal of finding the 20 best films to recommend to all users. Given that everyone has a different internal 5-star scale (i.e., a rating of three stars to me is different than three stars to you), reliance is placed on pairwise comparisons of movies, e.g., “Is movie A better than movie B?”. Here it was also assumed that the system does not have the ability to query these specific questions to the user, instead the user simply reveals some number of comparisons (which for the sake of analysis are assumed to be chosen completely at-random, although this is not required). This allows for the invention to exploit passive information that the user already reveals. For example, instead of explicitly asking the user if they prefer movie A or movie B, this system could rely on existing viewing information (user A watched 4 episodes of show A and only 2 episodes of show B, therefore they prefer show A over show B). Using this invention, these preferences can be incorporated in order to estimate the top-items in the collection (i.e., the top 20 films out 1,000,000 films in the database).

If all the pairwise comparisons are observed, then PathRank methodology will only return the top-k items. FIG. 2 is an example of five items in ranked order (where 1 [symbol] ,2 [symbol] 3 [symbol] 4 [symbol] 5), with the goal of finding the top-3 items. The far left graph of FIG. 2 is an example of an incomplete comparison graph where only four of the possible ten pairwise comparisons were observed. The center graph of FIG. 2 is an example of PathError due to incompleteness, where the fourth ranked item has no observed paths of length>3 and, therefore, is returned erroneously as a top-3 item. The far right graph of FIG. 2 shows the fifth item being correctly discarded since the path length is greater than 3. Of course, if not all the pairwise comparisons are observed (i.e., p<1), then due to missing 3 edges, items ranked far from the top-k items could potentially have no>k-paths observed and therefore be erroneously returned as a top-ranked item. Even with very few observed comparisons the bottom ranked items will be able to be discarded, as demonstrated in FIG. 2 (right). In Theorem 3.1, the lowest-ranked item returned using PathRank is bounded for a specified probability of pairwise comparison observations, p is bounded.

Theorem 3.1. Consider N items with unknown underlying ranking {π₁, π₂, . . . , π_{N}}, and the at-random observation of pairwise comparisons with independent and identically distributed random variables with probability p>0. Then, with probability ≧(1-α) (where α>0), the PathRank methodology from Algorithm 1 only returns items from the

$$top - ( \frac{2 k ( 1 - p )}{p} + 2 log ( \frac{N}{α} ) ) for some constant k > 0.$$

Proof. Consider a collection of X+1 items (where X>k). For ease of notation, it is assumed here that these items are ordered 1 [symbol] 2 [symbol] 3 [symbol] +1, although this is not required. First determine the probability that a path of length k+1 is found starting from the (X+1)-th ranked item. The probability that a path goes through a specific choice of k items (not counting the X+1 item) is p^{k} (1-p)^{X-k}, where k pairwise comparisons must be observed to determine the path and X-k pairs must not be observed to ensure that no prior k path exists through the collection of X items. Given

$$( \begin{matrix}X \\ k\end{matrix} )$$

possible choices, it can be stated that the probability of a k-path through X items is

$$( \begin{matrix}X \\ k\end{matrix} ) {{p}^{k} ( 1 - p )}^{X - k}$$

Note mat this does not eliminate the possibility of a path longer than k, only that the first k path found uses the specified combination of k items out of X total items. A path of length>k could be feasible at item k +1, k+2, . . . , X+1, therefore it can be stated that the total probability of a path of length>k being observed as

$${\sum }_{Y = k}^{X} ( \begin{matrix}X \\ k\end{matrix} ) {{p}^{k} ( 1 - p )}^{Y - k} .$$

As a result, the probability that X items do not result in a path of length>k is the tail probability of a negative binomial distribution with parameters k and p. Therefore, by bounding the tail probability by

$$\frac{α}{N}$$

(due to the union bound) and using Chernoff's bound to solve for X, proves the result.

Consider the situation where elements of the comparison matrix, cᵢⱼ to evaluate can be chosen, and there is confidence that all returned values of this query were accurate (i.e., the probability of incorrect comparison, q=0). When this occurs, the top-k search problem reduces to a sorting problem, where the comparison query can be considered answers to a bisection search question using the desired item against a set of preordered k+1 items. The query complexity of this technique is therefore an extension of Quicksort bounds as explored for ranking in the prior art and is stated in Lemma 1.

Lemma 1. Consider N items with unknown underlying ranking {π₁, π₂, . . . , π_{N}}. If the probability of erroneous pairwise comparison, q=0, then using Quicksort the top-k items can be found using only at most N log₂ (k+1) adaptively-chosen pairwise comparisons.

Now consider that there is a non-zero probability that a queried pairwise comparison returns incorrect information with respect to the underlying ranking of the items (i.e., q>0). Focus on the regime where only a single, potentially erroneous, comparison is available for each pair, as the ability to query a specific pair of items multiple times makes the solution obvious. Using a Quicksort-based methodology, even a single erroneous comparison has the potential to disrupt the ability to determine the top-k items, as a bisection search will make an incorrect decision and result in erroneous ranking for this item. Due to these limitations, a new methodology is needed that is robust to comparison errors.

To design a technique that is robust to a potentially large number of pairwise comparison errors, reliance is placed upon selecting random subsets of items (i.e., “voting items”) and determining if every item is in the top-k ranked items by querying multiple observed pairwise comparisons (i.e., “votes”). This algorithm will use these votes to determine some fraction of the bottom ranked items, allowing for the removal of these items from consideration. Specifically, given N unranked items (with unknown underlying ranking {π₁, π₂, . . . , π_{N}}) a goal of the present invention is to return a reduced set of items, with the bottom-N/8 items (i.e., {xε{=1, 2, . . . , N}:πₓ>(7N)/8}) removed, while the top-N/8 items (i.e., {xε{ 1, 2, . . . , N}:πₓ≦(N/8)}) are retained. Extending these techniques for removing larger or smaller fraction of the items would follow from the analysis presented herein.

The methodology of the present invention proceeds as follows. First, a subset of items is randomly selected as voting items. Given an item i, it would be preferable to use selected pairwise comparisons with the voting items to determine via majority vote if item i is in the bottom- N/8 items (and therefore should be removed). Unfortunately, to distinguish between the bottom-N/8 and the top-N/8 items, not all possible voting items will be informative. For example, comparing an item i (where πᵢ<N) with the lowest ranked item will always result in item i being returned as the higher ranked item unless there is a comparison error. As a result, a selected subset of voting items is needed, such that every remaining voting item is informative as to determining between the bottom and top ranked items.

To find informative voting items, a preliminary set of candidate voting items is chosen at-random from the set {1, 2, . . . , N}. Each of the candidate voting items is compared against the set of all items. Given these comparisons, the voting items at the extremes are removed (i.e., the items found to be very often the top or bottom ranked with respect to all other items). The reduced set of voting items, containing the items found not to be at the extremes of the ranking, are then used to efficiently determine which items are ranked in the bottom-N/8. The two-stage voting methodology of the present invention is described in the adaptiveReduce methodology in Algorithm 2, with performance guarantees specified in Theorem 4.1.

Specifically at step 1 of the method of algorithm 2, a subset of items from the set X is chosen at random (X_{random}) The number of items chosen at random is n_{random}, where n_{random} is greater than or equal to (16(½-q)⁻²+32) log N N. The items of subset X_{random} are denoted as the voting items. At step 2 of the method of algorithm 2, the validation counts are found for each voting item. Validation counts are the “votes” resulting from querying multiple observed pairwise comparisons. That is, each item in the subset X_{random} is queried to determine how many times it is a lower rank than each item i in the set X. The validation count (the number of times that an item in the subset is a lower rank than items i in the set X) is used to refine the voting item set by removing the top and bottom ranked items (retaining the items in the middle of the subset X_{random}). Call this reduced (refined) subset of X_{random}, X′_{random}. This reduced (refined) subset is then used to find the voting counts (the number of times each item in the set X is ranked higher than each items in the reduced (refined) subset). This permits reduction of the set X to discard (eliminate) those items that are at the bottom (N/8) subset (X′_{random}) of the set X. Call this further reduced subset Y. The above process returns the set Y to Algorithm 3. Algorithm 3 sets Y equal to X and performs a test to ensure that the number of items in X are sufficient to determine the top-k ranked items. Specifically, the number of items in X is at least max

$$\{ \frac{4 log N}{{α}_{T} log ( \frac{8}{7} )} , 64 log ( \frac{4 log N}{{α}_{T} log ( \frac{8}{7} )} ) + 2 log 64 - 2 \} .$$

Algorithm 2-ADAPTIVEREDUCE(X,q)

Given:

| | |
|---|---|
| 1. | Set of N unranked items, X = {1, 2, ..., N}. |
| 2. | Probability of erroneous pairwise comparison, q. |

Method:

| | |
|---|---|
| 1. | Find X_{random}, a subset of n_{random} ≧ |
| | (16 (½ − q)⁻² + 32) log N randomly chosen |
| | candidate voting items out of the N total items. |
| 2. | Find the validation counts for each candidate |
| | voting item, vⱼ = Σᵢ₌₁^{N}c_{j,i} for all j ε X_{random}. |
| 3. | Refine the voting item subset, |
| | ${X}_{vote} = \{ x ∈ {X}_{random} \text{:} \frac{N}{4} \leq {v}_{x} \leq \frac{3 N}{4} \} .$ |
| 4. | Find the voting counts for each item, |
| | tᵢ = Σ_{xεX}_{ᵥₒₜₑ} c_{i,x} for all i = {1, 2, ..., N}. |
| 5. | Determine the reduced set of top-ranked items, |
| | $Y = \{ y ∈ \{ 1 , 2 , … , N \} \text{:} {t}_{y} \geq \frac{\vert {X}_{vote} \vert}{2} \} .$ |

Output:

Return the reduced set of items, Y.

Theorem 4.1. Consider N items with unknown underlying ranking {π₁, π₂, . . . , π_{N}}, and the ability to adaptively query pairwise rank comparisons of any two items. If the probability of incorrect comparison,

$$q \leq min \{ \frac{1}{2} - {( \frac{N}{4 log ( \frac{4 N}{α} )} )}^{- 2} , \frac{1}{\frac{3}{4} ( N - 1 )} ( \frac{N}{8} - {( \frac{N - 1}{2} log ( \frac{16 N}{α} ) )}^{1 / 2} ) \}$$

and the number of items is large enough with

$$N \geq max \{ \frac{4}{α} , 64 log ( \frac{4}{α} ) + 2 log 64 - 2 \} ,$$

then with probability≧(1-α) (where α≧0) using the adaptiveReduce methodology from Algorithm 2, the bottom-N/8 items are removed and the top-N/8 items are retained using at most (16(½-q)⁻²+32)N log N adaptively-chosen pairwise comparisons.

Proof. By combining the results from Propositions 1, 2, 3, and 4, Theorem 4.1 is proven as follows.

As stated above, to discriminate between the top and bottom ranked items requires an intelligently selected set of voting items which are located in the center of the ranking. Eventually a technique is described to determine this collection of voting items, first, however, consideration is given as to when an informative collection of voting items are available to the algorithm. To begin, consider prior knowledge of a selected set of nᵥₒₜₑ number of voting items, denoted by the set Xᵥₒₜₑ, where every element of this set is in middle-{N/8 , 7N/8} items (i.e., Xᵥₒₜₑ⊂{xε{1, 2, . . . , N}:N/8<πₓ≦7N/8}). Using this selected set of voting items, “voting counts” are evaluated for each unranked item i, where for all i={1, 2, . . . , N},

$${t}_{i} = {\sum }_{x ∈ {X}_{vote}} {c}_{i , x} \qquad ( 4 )$$

Therefore it is observed that the voting counts of the bottom-N/8 items behave like,

t_{bottom}˜binomial (nᵥₒₜₑ, q) (5)

Given that all the selected voting items are ranked higher than the bottom-N/8 items, and therefore the pairwise comparison (c_{i,x}) will only equal 1 if there is an error.

Similarly, it is observed that the voting counts for the top-N/8 items,

tₜₒₚ˜binomial (nᵥₒₜₑ,1-q) (6)

Where, for these top ranked items, it is found that the pairwise comparisons (c_{i,x}) will only return 0 if there is a comparison error. If the number of voting items nᵥₒₜₑ is large enough and the error rate q is not too large, then this stipulates a clear gap between these two distributions. By thresholding on these voting counts by the gap midpoint (nᵥₒₜₑ/2) and creating a subset of top-ranked items, such that X*={xε{ 1, 2, . . . , N}:tₓ≧nᵥₒₜₑ/2}, the bottom-N/8 items can be eliminated while ensuring that the top-N/8 items are retained.

Proposition 1. Consider the set X containing N items with unknown ranking {π₁, π₂, . . . , π_{N}} and the ability to query pairwise rank comparison with independent and identically distributed random variable with the probability of error q<1/2 . Given nᵥₒₜₑ number of voting items in middle-{N/8, 7N/8} (the set Xᵥₒₜₑ, where Xᵥₒₜₑ ε{1, 2, . . . , N):N/8<π≦7N/8}), and defining voting counts

$${t}_{i} = {\sum }_{x ∈ {X}_{vote}} {c}_{i , x}$$

for item i. If nᵥₒₜₑ≧1/2 log (16N/α)((1/2)-q)⁻² then the set X*={xε{1, 2, . . . , N}:tₓ≧nᵥₒₜₑ/2} will contain the top-N/8 items of X and omit the bottom-N/8 items of X with probability≧1-(α/4) where α>0.

Proof. To remove the bottom-N/8 items, it is required that tₓ<nᵥₒₜₑ/2 for all items {x ε{1, 2, . . . , N}:π_{c}>7N/8}. Using the distribution stated in Equation 5 and both Hoeffding's Inequality and a union bound over all possible items, it is found that this is satisfied if q<2 , and nᵥₒₜₑ≧1/2 log (8N/α) ((1/2)-q)⁻².

To ensure that the top-N/8 items are preserved, it is required that tₓ≧nᵥₒₜₑ/2 for all items {xε{1, 2, . . . , N}:πₓ≦N/8}. Again simplifying using both union and Hoeffding's bound, it is found that this is satisfied if q<2 , and nᵥₒₜₑ≧1/2 log (16N/α) ((1/2)-q)⁻².

Combining both bounds, it is found that the set X*={x:tₓ≧nᵥₒₜₑ/2} will contain the top-N/8 items of X and omit the bottom-N/8 items of X with probability ≧(1-(α/4)) where α>0 if q<2, and nᵥₒₜₑ≧1/2 log (16N/α) ((1/2)-q)⁻². This proves the result.

Unfortunately, a selected set of nᵥₒₜₑ, voting items all contained in the set middle-{N/8 , 7N/8} will not be known. To obtain this selected subset, initially obtain an at-random collection of n_{random} initial voting items, X_{random}, out of all N possible items (where the number of initial voting items will be larger than the final selection of voting items, n_{random}>nᵥₒₜₑ). Of course, the set X_{random} will contain items from throughout the ranking, not just items in the specified middle subset of the ranking. In the following procedure, it is described how to use queried pairwise comparisons to eliminate all the items at the extremes of the ranking.

To reduce this set of initial voting items to the desired subset, each of the voting items (jεX_{random}) are queried and compare that voting item with all items in X, calculating the number of times that a voting item j is higher ranked than any other item. This is denoted as “validation count” metric vⱼ for all voting items jεX_{random}, such that using the comparison queries (c_{j,i}) specified in Equation 1,

$${v}_{j} = {\sum }_{i = 1}^{N} {c}_{j , i} \qquad ( 7 )$$

To obtain the values of vⱼ for all j=1, 2, n_{random} therefore requires n_{random} N total pairwise comparison queries.

From these validation counts, if the count is too high, then the randomly chosen voting item may potentially be in the top-N/8 items, while if the validation count is too low then the item may be in the bottom-N/8 subset. Eliminate these non-informative voting items from the collection X_{random} by defining the final voting item set, Xᵥₒₜₑ={xεX_{random}:(N/4) ≦vₓ≦(3N/4)}. Guarantees for this final voting item set are stated in Proposition 2.

Proposition 2. Consider the set X containing N items with unknown ranking {π₁, π₂, . . . , π_{N}} and the ability to query pairwise rank comparison. Given the subset X_{random}, containing π_{random} number of randomly chosen voting items, define the reduced set of voting items, Xᵥₒₜₑ={xεX_{random}:(N/4)≦vₓ≦(3N/4)} (using the validation counts, v, from Equation 7). Then, with probability≧1-α/4 , with α>0, the subset Xᵥₒₜₑ will not contain any of the top-N/8 items or the bottom-N/8 items if the probability of pairwise comparison error,

$$q \leq \frac{1}{\frac{3}{4} ( N - 1 )} ( \frac{N}{8} - {( \frac{N - 1}{2} log ( \frac{16 N}{α} ) )}^{1 / 2} )$$

Proof. Given the noise model in Equation 2 and the definition of the voting metric in Equation 7, it follows that each of these voting metric values is distributed as a mixture of two binomials, such that for the i-th ranked item, where {xε{1, 2, . . . , N}:πₓ=i},

vₓ˜binomial (i-1,q)+binomial (N-i,1-q) (8)

Where the i-th item is declared to be ranked higher than i-1 other items only if there is an erroneous pairwise comparison (with probability q), and the i-th item is found to be ranked higher than N-i items if the pairwise comparison is not erroneous (with probability 1-q).

Taking the union bound over all possible N items, it can be stated that the probability that any of the top-N/8 items are in the final voting item set using Hoeffding's bound, such that for all xε{1, 2, . . . , N} where πₓ≦N/8},

$$P ( {v}_{x} \leq \frac{3 N}{4} ) \leq 2 exp ( \frac{- 2 {( \frac{N}{8} - q - \frac{3 Nq}{4} )}^{2}}{N - 1} ) \leq \frac{α}{8 N}$$

Bounding the probability that the bottom-N/8 items are in the final voting set follows from this analysis, and solving for q returns the result.

Of course, enough voting items are needed in Xᵥₒₜₑ to be robust to erroneous comparisons, therefore in Proposition 3 it is shown that that all the items chosen from middle-{3N/8, 5N/8} in X_{random} will remain in Xᵥₒₜₑ with probability ≧1-(α/4), with α>0.

Proposition 3. Consider the set X containing N items with unknown ranking {π₁, π₂, . . . , π_{N}} and the ability to query pairwise rank comparison with independent and identically distributed random variables with probability of error q<1/2 . Given the subset X_{random}, containing n_{random} number of randomly chosen voting items, define the reduced set of voting items, Xᵥₒₜₑ={xεX_{random}:N/4≦vₓ23 3N/4} (using the validation counts, vᵢ, from Equation 7). Then with probability≧1-(α/4), with α>0, the subset Xᵥₒₜₑ will contain all items of X_{random} in middle-{3N/8 , 5N/8} if N≧64 log (4/α)+2 log 64-2.

Proof. From Equation 8 and Hoeffding's Inequality it can be stated that, such that for all xε{1, 2, . . . , N} where πₓ≧3N8,

$$P ( {t}_{x} \geq \frac{3 N}{4} ) \leq exp ( \frac{- 2 {( \frac{N}{8} + ( 1 + \frac{N}{4} ) q )}^{2}}{N - 1} ) \leq \frac{α}{8 N}$$

can be found and for all xε{1, 2, . . . , N} where πₓ≦5N/8

$$P ( {t}_{x} \leq \frac{N}{4} ) \leq 2 exp ( \frac{- 2 {( \frac{N}{8} + ( 1 + \frac{N}{4} ) q )}^{2}}{N - 1} ) \leq \frac{α}{8 N}$$

can be found.
Rearranging both terms and using log N≦N/64+log 64-1, it is found that both inequalities are satisfied if, N≧64 log (16/α)+2 log 64-2.

Finally, it can be shown that if the total number of randomly-chosen voting items (n_{random}) is large enough, then the number of items chosen in middle-{3N/8, 5N/8} (i.e., a lower bound on the size of the reduced voting set, Xᵥₒₜₑ) will be greater than or equal to the required number of selected voting items from Proposition 1.

Proposition 4. Consider the set X containing N items with unknown ranking {π₁, π₂, . . . π_{N}}. If n_{random}≧(16(½-q)⁻²32)log N items are selected at-random, then with probability≧1-(α/4) (for α>0) there will be at least

$$\frac{1}{2} log ( \frac{4 N}{α} ) {( \frac{1}{2} - q )}^{- 2}$$

items chosen in middle-{3N/8, 5N/8} of X if the total number of items is large enough, N≧4/α and the probability of erroneous comparison

$$q \leq \frac{1}{2} - {( \frac{N}{4 log ( \frac{4 N}{α} )} )}^{- 2} .$$

Proof. To show that sampling without replacement from N items returns the desired result, consider simplifying the bound in terms of sampling with replacement. First, rearrange the results of Proposition 1 to find that if

$$q \leq \frac{1}{2} - {( \frac{N}{4 log ( \frac{4 N}{α} )} )}^{- 2} ,$$

then the desired number of items in middle-{3N/8, 5N/8} in the underlying ranking is less than N/8. Next, lower bound the number of randomly items chosen in X_{random} in middle-{3N/8, 5N/8} using z˜binomial (n_{random}, 1/8). Therefore, the proposition holds if,

$$P ( z < \frac{1}{2} log ( \frac{4 N}{α} ) {( \frac{1}{2} - q )}^{- 2} ) \leq \frac{α}{4}$$

Using Hoeffding's Inequality, it is found that

$$\frac{1}{2} log ( \frac{4 N}{α} ) {( \frac{1}{2} - q )}^{- 2}$$

items are chosen are in the middle-{3N/8, 5N/8} if the probability of erroneous comparisons,

$$q \leq \frac{1}{2} - {( \frac{N}{4 log ( \frac{4 N}{α} )} )}^{- 2} ,$$

N≧4/α, and n_{random}≧(16(½-q)log N.

Combining results from Propositions 1-4, it is found that if the probability of erroneous comparison,

$$q \leq min \{ \frac{1}{2} - {( \frac{N}{4 log ( \frac{4 N}{α} )} )}^{- 2} , \frac{1}{\frac{3}{4} ( N - 1 )} {( \frac{N}{8} - ( \frac{N - 1}{2} log \frac{16 N}{α} ) )}^{1 / 2} ) \} ,$$

and the total number of items N≧max {(4/α), 64 log (4/α)+2 log 64-2}, then using the adaptiveReduce algorithm, the bottom-N/8 items will be removed and the top-N/8 items will be preserved with probability≧1-α(with α>0).

From Equation 7 and Proposition 4, it is found that at most (16(½-q)⁻²+32)N log N pairwise comparisons are needed for the adaptiveReduce algorithm to succeed. This proves Theorem 4.1.

The adaptiveReduce algorithm only reduces the set of N items to the subset of top-≦(7N)/8 items. In order to further reduce the subset of top ranked items, this technique is repeatedly executed on each of the returned subsets of items. Of course, there are limits to size of the top subset that can be resolved, enough voting items need to be obtained to ensure that the erroneous pairwise comparisons are defeated. In Theorem 4.2 the total number of adaptively chosen pairwise comparisons needed to resolve the top O (log N) items is stated.

Theorem 4.2. Consider N items with unknown underlying ranking {π₁, π₂, . . . , π_{N}}, and the ability to adaptively query pairwise rank comparisons of any two items. If the probability of incorrect comparison,

$$q \leq min \{ \frac{1}{2} - \frac{1}{{N}^{2}} {( 4 log ( \frac{4 N log N}{{α}_{T} log ( \frac{8}{7} )} ) )}^{2} , {( \frac{3}{4} N + 1 )}^{- 1} ( \frac{N}{8} - {( \frac{N - 1}{2} log ( \frac{16 N}{{α}_{T}} ) )}^{1 / 2} ) \}$$

and the total number of items N is large enough, then using the robustAdaptiveSearch methodology, with probability≧(1-α^{τ}) (where α_{τ}>0) the top-max

$$\{ \frac{4 log N}{{α}_{T} log ( \frac{8}{7} )} , 64 log ( \frac{4 log N}{{α}_{T} log ( \frac{8}{7} )} ) + 2 log 64 - 2 \}$$

will be found using at most

$$\frac{( 16 {( \frac{1}{2} - q )}^{- 2} + 32 )}{{α}_{T} log ( \frac{8}{7} )} N {log}^{2}$$

N adaptively-chosen pairwise comparisons.

Proof. Given that each iteration of the adaptiveReduce Algorithm will remove the bottom-(≧⅛) fraction of the items from consideration, then from Lemma 2 in the Appendix, at most

$$\frac{log N}{log \frac{8}{7}}$$

executions of the adaptiveReduce Algorithm will be performed until there are not enough voting items left to defeat erroneous pairwise comparisons. Combining this with the results of Theorem 4.1, this theorem is proved as follows.

The robustAdaptiveSearch algorithm recursively calls the adaptiveReduce subalgorithm until there are no longer enough items remaining to defeat erroneous comparisons. In Lemma 2, it is shown that only O (log N) calls to adaptiveReduce will be performed.

Lemma 2. Given the adaptiveReduce methodology removes>⅛-th of the items, then this method can be recursively performed at most

$$\frac{log N}{log \frac{8}{7}}$$

times.

Finally, for the robustAdaptiveSearch methodology to succeed with probability≧1-α_{τ}for α_{τ}>0, this requires that each of the O (log N) executions of the adaptiveReduce technique succeeds. Therefore, setting

$$α = \frac{{α}_{T} log \frac{8}{7}}{log N}$$

in Theorem 4.1, proves Theorem 4.2.

While the derived bounds above reveal regimes where the robustAdaptiveSearch algorithm will succeed with high probability, the use of conservative concentration inequalities and union bounds indicate that in practice these methods may work well in regimes where success cannot be proved (e.g., when 40% of the observed comparisons are incorrect, q=0.4). Table 1, shows the performance of the robustAdaptiveSearch algorithm in synthetic experiments across a wide range of item sizes, N, and incorrect pairwise comparisons probabilities, q. As seen in Table 1 where the methodology is executed until a subset of <50 items are found, the methodology performs well with a subset of items in the top-39 ranked items for q=0.1 (and the top-155 ranked items for q=0.4), across all experiments, even in regimes where no performance guarantees are available.

TABLE 1
Performance of RobustAdaptiveSearch algorithm given specified
N and q values. Results are for the top ranked subset ≦50 items
found, and averaged across 100 experiments.

| | Fraction of | Total | Fraction | Lowest |
|---|---|---|---|---|
| | incorrect | Number of | of Total | Ranked Item |
| Number of | comparisons | Comparisons | Comparisons | Returned |
| items (N) | (q) | Used | used | (out of N) |
| 1,000 | 0.10 | 1.33 × 10⁵ | 0.267 | 34.67 |
| 10,000 | 0.10 | 1.83 × 10⁶ | 3.66 × 10⁻² | 36.31 |
| 100,000 | 0.10 | 2.31 × 10⁷ | 4.61 × 10⁻³ | 38.21 |
| 1,000,000 | 0.10 | 2.77 × 10⁸ | 5.53 × 10⁻⁴ | 36.14 |
| 1,000 | 0.40 | 1.26 × 10⁵ | 0.253 | 153.62 |
| 10,000 | 0.40 | 1.84 × 10⁶ | 3.69 × 10⁻² | 117.21 |
| 100,000 | 0.40 | 2.21 × 10⁷ | 4.42 × 10⁻³ | 107.85 |
| 1,000.000 | 0.40 | 1.84 × 10⁸ | 5.56 × 10⁻⁴ | 101.26 |

Algorithm 3-RobustAdaptiveSearch(X,q,α_{T})

| Given: | |
|---|---|
| 1. | Set of N unranked items, X = {1, 2, ..., N}. |
| 2. | Probability of erroneous pairwise comparison, q ≧ 0. |
| 3. | Probability of methodology failing, α_{T} > 0. |

| Repeated Pruning Process: | |
|---|---|
| 1. | While |
| | $\vert X \vert > max \{ \frac{4 log N}{{α}_{T} log ( \frac{8}{7} )} , 64 log ( \frac{4 log N}{{α}_{T} log ( \frac{8}{7} )} ) + 2 log 64 - 2 \}$ |
| (a) | Update the set of items, |
| | Y = AdaptiveReduce(X,q). |
| | X = Y |
| Output: | |
| | Return X, the resolved top ranked items. |

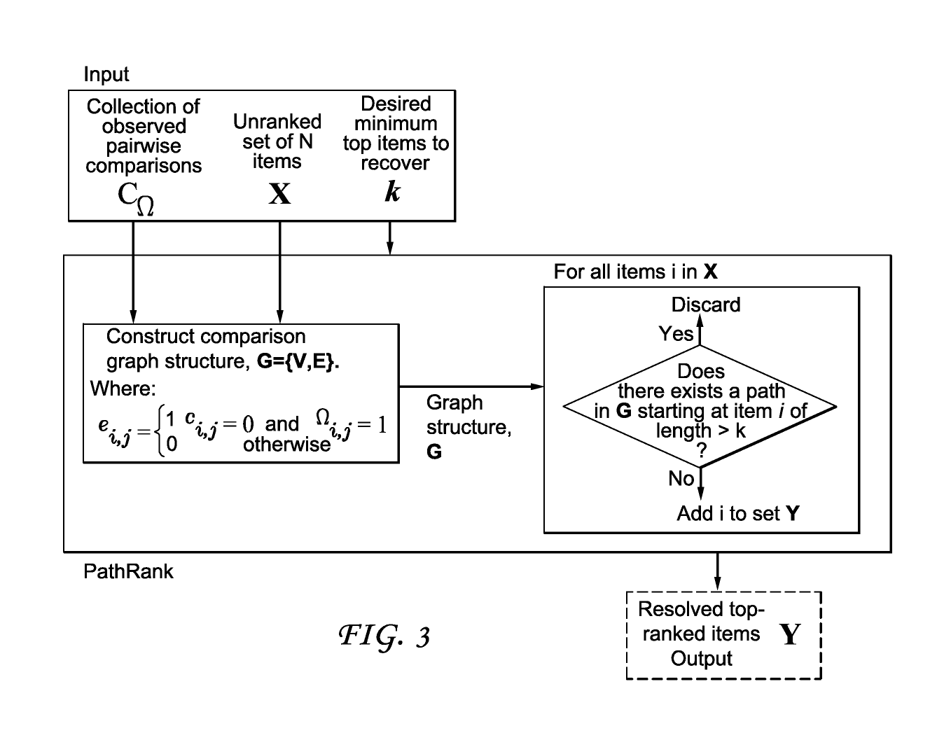

FIG. 3 is a diagram of an exemplary PathRank algorithm in accordance with the principles of the present invention. Using graph-based analysis, a constant-fraction of the randomly observed comparisons is used to resolve the top O (log N) items when the pairwise comparisons perfectly conform to the underlying item ranking. It is assumed that there are no ties in the ranking and the probability of error is assumed to be 0. The PathRank algorithm accepts (receives) a set X of N unranked items, a collection of observed pairwise comparisons and the desired minimum top number of items (k) to be determined (recovered). A graph is constructed (created). Using the graph structure, a depth-first search is performed for each item i e X. The items with no paths through the graph that are >k in length are saved in the set Y as the top-k ranked items.

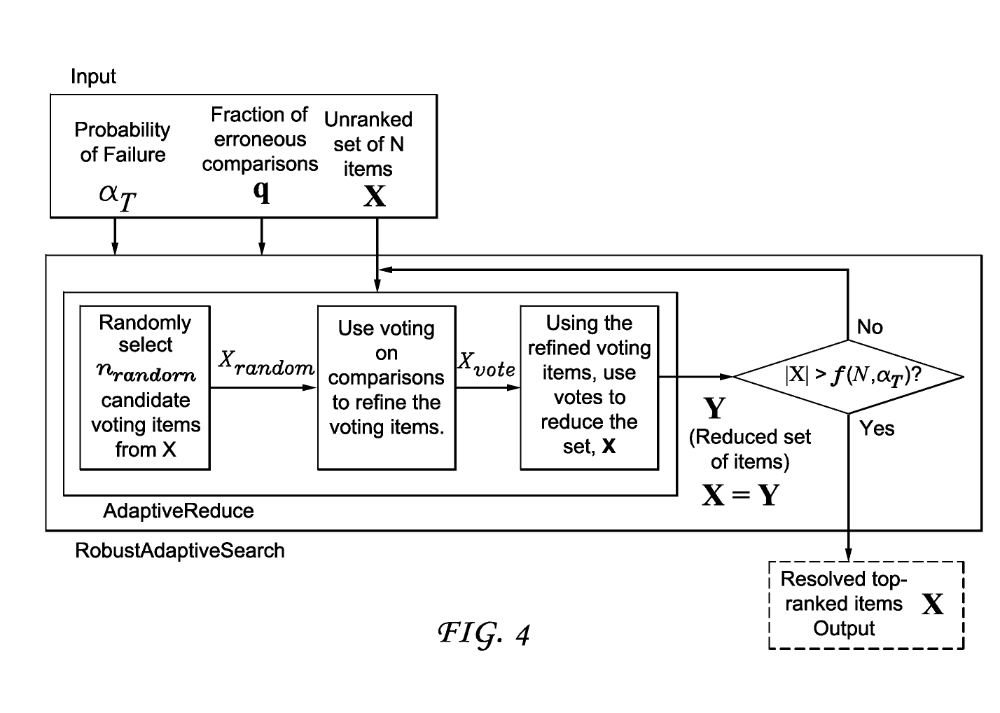

FIG. 4 is a diagram of exemplary RobustAdaptiveSearch and AdaptiveReduce algorithms in accordance with the principles of the present invention. When a fraction of the comparisons are erroneous, results showed that the items from the top O (log N) items can be recovered with high probability using only O(N log²N) adaptively chosen comparisons.

The method receives (accepts) the set of N unranked items X={1,2, . . . , N}, the probability of erroneous pairwise comparison (q>0) and the probability of methodology failure (α_{τ}>0). A test is performed to ensure that there are enough items in X to determine the top-k items. If there are sufficient items than the AdaptiveReduce algorithm is called to determine a reduced set of items. The AdaptiveReduce portion of the method randomly selects a subset of the set X (X_{random}) which is further reduced (refined) by removing the extremes (X′_{random}) Once the extremes are removed from the set (X′_{random})_{,} the bottom N/8 items are removed from the set X. This set of the remaining items is set equal to Y, which is returned to the RobustAdaptiveSearch.

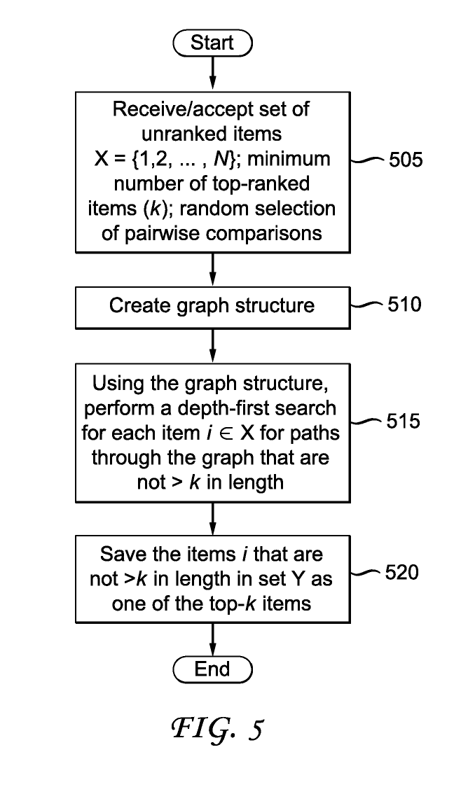

FIG. 5 is a flowchart of an exemplary PathRank algorithm in accordance with the principles of the present invention. At 505 the PathRank algorithm accepts (receives) a set X of N unranked items, a collection of observed pairwise comparisons and the desired minimum top number of items (k) to be determined (recovered). At 510, a graph is constructed (created). At 515, using the graph structure, a depth-first search is performed for each item i e X for paths through the graph that are not >k in length. At 520, these items are saved in the set Y as the top-k ranked items.

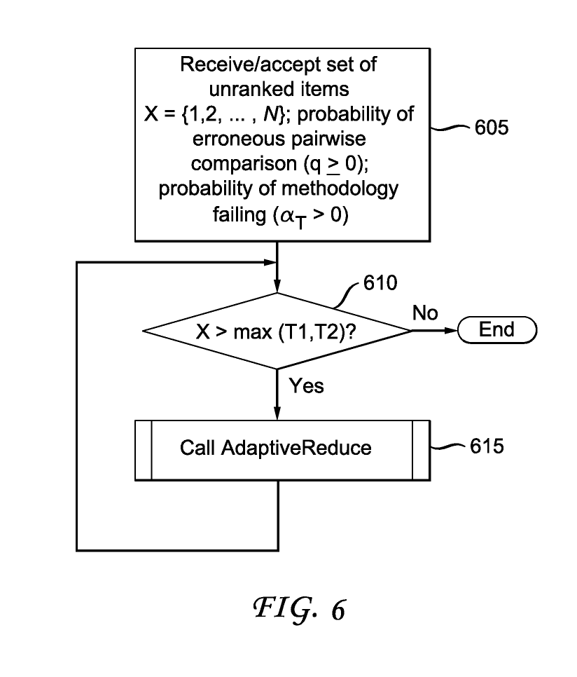

FIG. 6 is a flowchart of an exemplary RobustAdaptiveSearch algorithm in accordance with the principles of the present invention. At 605, the method receives (accepts) the set of N unranked items X={1,2, . . . , N}, the probability of erroneous pairwise comparison (q≧0) and the probability of methodology failure (α_{τ}>0). A test is performed to ensure that there are enough items in X to determine the top-k items. This is indicated by comparing X to two thresholds. The number of items in X is at least max

$$\{ \frac{4 log N}{{α}_{T} log ( \frac{8}{7} )} , 64 log ( \frac{4 log N}{{α}_{T} log ( \frac{8}{7} )} ) + 2 log 64 - 2 \} .$$

If there are sufficient items then at 615 the AdaptiveReduce algorithm is called to determine a reduced set of items. The reduced set of items is Y, so this must be set to be X for the next iteration.

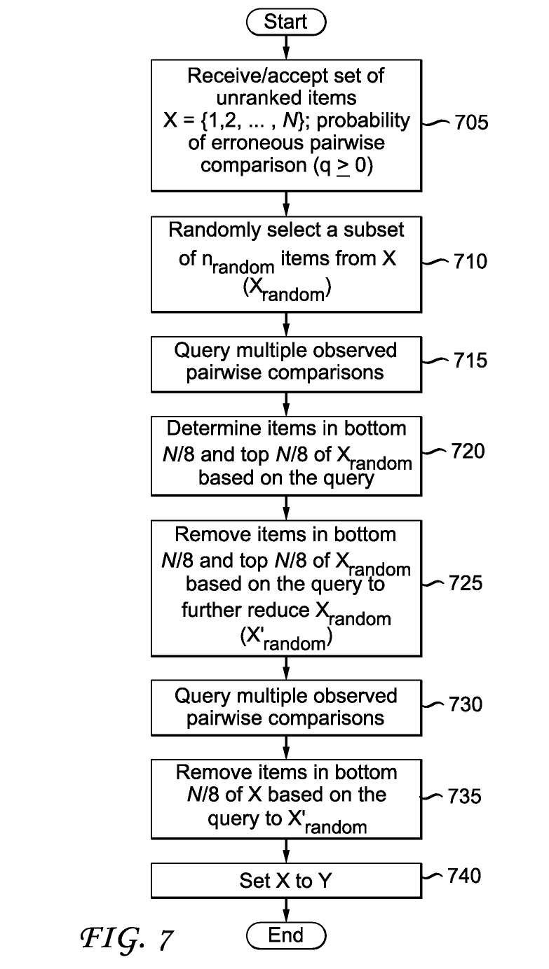

FIG. 7 is a flowchart of an exemplary AdaptiveReduce algorithm in accordance with the principles of the present invention. At 705, the AdaptiveReduce algorithm receives (accepts) the set of unranked items X={1, 2,. . . , N} and the probability of erroneous pairwise comparison (q≧0). At 710, a subset of n_{random} items from X is selected. Denote this as X_{random}. n_{random} must be greater than or equal to (16(½-q)⁻²+32)log N. At 715, multiple observed pairwise comparisons are queried. This involves looping through the items in X_{random} and comparing the items in X_{random} to all of the items in X. At 720, the items in bottom N/8 and top N/8 of X_{random} are determined based on the query. At 725, the items in bottom N/8 and top N/8 of X_{random} are removed based on the query to further reduce X_{random}. Denote this as set X′_{random}. At 730, the multiple observed pairwise comparisons are queried again. This involves looping through the items in X′_{random} and comparing the items in X′_{random} to all of the items in X. At 735, the items in the bottom N/8 of X are removed based on the query to the subset X′_{random}. Denote this set as Y. At 740 set Y is returned to the RobustAdaptiveSearch algorithm that called the AdativeReduce algorithm.

FIG. 8 is a block diagram of an exemplary embodiment of the PathRank method of the present invention. The communications interface is coupled to the create graph module. The create graph module is coupled to the search paths in graph module. The search paths in graph module is coupled to the communications interface. The communications interface provides the means for accepting a set of unranked items, the pre-determined number, and a random selection of pairwise comparisons. The create graph module provides the means for creating a graph structure using the set of unranked items and the random selection of pairwise comparisons, wherein the graph structure includes vertices corresponding to the items and edges corresponding to a pairwise ranking. The search paths in graph module provides the means for performing a depth-first search for each item that is an element of the set of unranked items for paths along the edges through the graph that are not greater than a length equal to said pre-determined number. FIG. 8 also includes memory (storage) not shown but accessible from all other modules in FIG. 8.

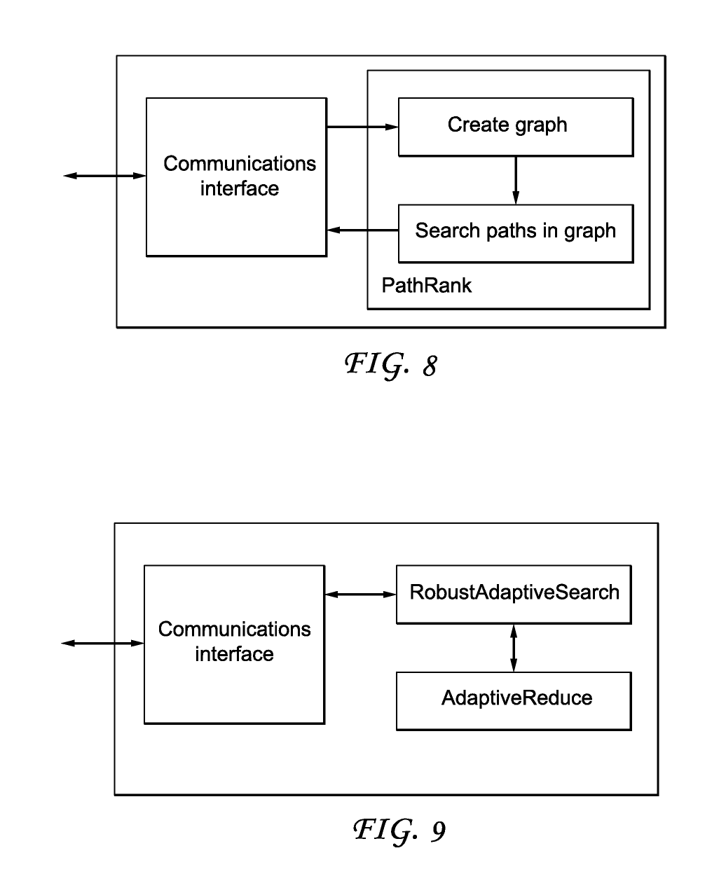

FIG. 9 is a block diagram of an exemplary embodiment of the RobustAdaptiveSearch and AdaptiveReduce methods of the present invention. The communications interface is bi-directionally coupled to the RobustAdaptiveSearch module. The RobustAdaptiveSearch module is bi-directionally coupled to the AdaptiveReduce module. The communications interface provides the means for accepting a set of unranked items, a probability of erroneous pairwise comparisons, and a probability of the method failing. The RobustAdaptiveSearch module provides the means for determining if the set of unranked items is greater than a maximum of a first threshold and a second threshold. The RobustAdaptiveSearch module provides the means for iteratively calling the following means, the means being included in the AdaptiveReduce module. The AdaptiveReduce module provides the means for accepting the set of unranked items, and the probability of erroneous pairwise comparisons, the means for randomly selecting a pre-determined number of items from the set of unranked items. The AdaptiveReduce module provides the means for querying multiple observed pairwise comparisons. The AdaptiveReduce module provides the means for determining items of the set of unranked items that are in a top portion and a bottom portion of the set of unranked items based on the query. The AdaptiveReduce module provides means for reducing the set of unranked items by removing the items in the bottom portion and the top portion of the set of unranked items responsive to the determining means. The AdaptiveReduce module provides the means for querying the multiple observed pairwise comparisons. The AdaptiveReduce module provides the means for reducing the set of unranked items by removing items in the bottom portion of the set of unranked items responsive to the second querying means. The

AdaptiveReduce module provides the means for returning the reduced set of unranked items. FIG. 9 also includes memory (storage) not shown but accessible from all other modules in FIG. 9.

Learning to rank from pairwise comparisons is necessary in problems ranging from recommender systems to image-based search. Novel methodologies for resolving the top-ranked items from either adaptive or randomly observed pairwise comparisons have been presented herein. Using graph-based analysis, a constant-fraction of the randomly observed comparisons was used to resolve the top O (log N) items when the pairwise comparisons perfectly conform to the underlying item ranking. When a fraction of the comparisons are erroneous, results showed that the items from the top O (log N) items can be recovered with high probability using only O (N log² N) adaptively chosen comparisons.

It is to be understood that the present invention may be implemented in various forms of hardware, software, firmware, special purpose processors, or a combination thereof. Special purpose processors may include application specific integrated circuits (ASICs), reduced instruction set computers (RISCs) and/or field programmable gate arrays (FPGAs). Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method for determining a pre-determined number of top ranked items, said method comprising:
accepting a set of unranked items, a probability of erroneous pairwise comparisons, and a probability of said method failing;
determining if said set of unranked items is greater than a maximum of a first threshold and a second threshold;
iteratively performing the following steps:
accepting said set of unranked items, and said probability of erroneous pairwise comparisons;
randomly selecting a pre-determined number of items from said set of unranked items;
querying multiple observed pairwise comparisons;
determining items of said set of unranked items that are in a top portion and in a bottom portion of said set of unranked items based on said query;
reducing said set of unranked items by removing said items in said bottom portion and said top portion of said set of unranked items responsive to said determining step;
querying said multiple observed pairwise comparisons;
reducing said set of unranked items by removing items in said bottom portion of said set of unranked items responsive to said second querying step; and
returning said reduced set of unranked items.

2. The method according to claim 1, wherein said first threshold is between N/4 and 3N/4 and said second threshold is N′/2, where N is a number of items in said unranked set of items and N′ is a number of reduced randomly selected items.

3. The method according to claim 1, wherein said top portion is N/8 and said bottom portion is N/8, where N is the number of items in said unranked set of items.

4. The method according to claim 1, wherein said pre-determined number of items randomly selected from said set of unranked items is greater than or equal to (16(½-q)⁻²+32)log N, where N is the number of items in said unranked set of items.

5. An apparatus for determining a pre-determined number of top ranked items, comprising:
means for accepting a set of unranked items, a probability of erroneous pairwise comparisons, and a probability of said method failing;
means for determining if said set of unranked items is greater than a maximum of a first threshold and a second threshold;
means for iteratively performing the following means:
means for accepting said set of unranked items, and said probability of erroneous pairwise comparisons;
means for randomly selecting a pre-determined number of items from said set of unranked items;
means for querying multiple observed pairwise comparisons;
means for determining items of said set of unranked items that are in a top portion and a bottom portion of said set of unranked items based on said query;
means for reducing said set of unranked items by removing said items in said bottom portion and said top portion of said set of unranked items responsive to said determining means;
means for querying said multiple observed pairwise comparisons;
means for reducing said set of unranked items by removing items in said bottom portion of said set of unranked items responsive to said second querying step; and
means for returning said reduced set of unranked items.

6. The apparatus according to claim 5, wherein said first threshold is N/4 to 3N/4 and said second threshold is N′/2, where N is a number of items in said unranked set of items and N′ is the number of reduced randomly chosen items.

7. The apparatus according to claim 5, wherein said top portion is N/8 and said bottom portion is N/8, where N is the number of items in said unranked set of items.

8. The apparatus according to claim 5, wherein said pre-determined number of items randomly selected from said set of unranked items is greater than or equal to (16(½-q)⁻²+32)log N , where N is the number of items in said unranked set of items.
